(19) United States
(12) Patent Application Publication
(10) Pub. No.: US 2022/0156377 A1
(43) Pub. Date: May 19, 2022

(54) FIRMWARE RUNTIME PATCH SECURE RELEASE PROCESS

(71) Applicant: Microsoft Technology Licensing, LLC, Redmond, WA (US)

(72) Inventors: Daini XIE, Redmond, WA (US); Yuwen CHOU, New Taipei City (TW); Wen-Ho CHEN, Taipei (TW)

(21) Appl. No.: 16/953,151

(22) Filed: Nov. 19, 2020

(51) Int. Cl. G06F 21/57; G06F 8/656

(52) U.S. Cl. CPC G06F 21/572; G06F 2221/033; G06F 21/577; G06F 8/656

(57) ABSTRACT

A secure firmware update patch release process includes providing (1) a test mode in firmware for performing firmware verification testing on a firmware update patch and (2) an additional signing applied to the firmware update patch after the firmware verification testing and before deployment of the firmware update patch in a production environment. A developer may generate and build a firmware update patch and release the patch for firmware verification testing. Before the firmware verification testing, a platform signature is added to the firmware update patch. The test mode may authenticate the firmware update patch based on the platform signature. If the firmware update patch passes the firmware verification testing, a system signature may be added to the firmware update patch. The system signature may be required to authenticate the firmware update patch while the firmware operates in an official mode of operation.

### CROSS-REFERENCE TO RELATED APPLICATIONS

N/A

### BACKGROUND

A cloud-computing system may refer to a collection of computing devices or resources that can be accessed remotely. A cloud-computing system may deliver computing services (such as storage, databases, networking, software, applications, processing, or analytics) over the Internet. A cloud-computing system may include a number of data centers that may be located in different geographic locations. Each data center may include many servers. A server may be a physical computer system.

Physical computing systems may include firmware. The firmware of a physical computing system may manage the functions of hardware components (such as processors, memory, and networking hardware) included in the physical computing system. For example, the firmware may be a Basic Input/Output System (BIOS). The firmware of a computing device may sometimes be updated in order to make changes such as fixing security flaws, adjusting hardware settings, fixing bugs in firmware functionality, enhancing reliability and serviceability features, or enabling or disabling hardware components. Before a firmware update is deployed, the firmware update may undergo firmware verification testing. The firmware verification testing may determine whether a computing device on which the firmware update is deployed will continue to operate correctly.

### SUMMARY

In accordance with one aspect of the present disclosure, a method is disclosed for enabling hardware verification testing of a firmware update patch. The method includes receiving the firmware update patch. The firmware update patch includes a payload. The payload includes code for modifying firmware. The firmware includes a standard mode and a test mode. The standard mode has a first set of verification checks for authenticating a patch that is different from a second set of verification checks for authenticating a patch of the test mode. The method further includes generating a platform signature using a platform private key and the firmware update patch. The method further includes adding the platform signature to the firmware update patch. The second set of verification checks of the test mode does not require a signature other than the platform signature to authenticate the firmware update patch but the first set of verification checks of the standard mode requires a signature other than the platform signature to authenticate the firmware update patch. The method further includes providing the firmware update patch to a tester.

A developer may have built the payload and adding the platform signature to the firmware update patch may not require re-building the payload.

The payload may include a payload header.

The firmware may be a Basic Input/Output System (BIOS) or a Unified Extensible Framework Interface (UEFI).

The firmware update patch may be a UEFI runtime patch (URP) capsule.

The method may further include adding a platform public key to the firmware update patch. The platform public key may authenticate the platform signature.

The test mode of the firmware may be selected only in a startup menu of the firmware.

In accordance with another aspect of the present disclosure, a system is disclosed for authenticating a firmware update patch for deployment on a node in a data center. The system includes one or more processors, memory in electronic communication with the one or more processors, one or more hardware components, and firmware for managing the one or more hardware components. The firmware includes a standard mode and a test mode. The standard mode includes a standard set of verification checks different from a test set of verification checks included in the test mode. The system also includes instructions stored in the memory. The instructions are executable by the one or more processors to receive the firmware update patch. The firmware update patch includes a platform signature and a cloud signature. The platform signature was generated using a platform private key and the cloud signature was generated using a cloud private key different from the platform private key. The instructions are also executable by the one or more processors to authenticate the firmware update patch while the firmware operates in the standard mode using the standard set of verification checks. The standard set of verification checks include verifying the platform signature and verifying the cloud signature. The instructions are also executable by the one or more processors to cause, after authenticating the firmware update patch, the firmware update patch to modify the firmware to generate modified firmware. The instructions are also executable by the one or more processors to manage the one or more hardware components based on the modified firmware.

Verifying the platform signature may include verifying the platform signature using a platform public key included in the firmware update patch.

Verifying the cloud signature may include verifying the cloud signature using a cloud public key included in the firmware update patch.

The firmware update patch may have undergone hardware verification testing while the firmware update patch included the platform signature but before the firmware update patch included the cloud signature.

The cloud signature may have added to the firmware update patch by an operator of the data center.

The test set of verification checks may not include verifying the cloud signature.

The firmware may be a Unified Extensible Framework Interface (UEFI) and the firmware update patch is a UEFI runtime patch (URP) capsule.

In accordance with another aspect of the present disclosure, a method is disclosed for performing hardware verification testing of a firmware update patch. The method includes receiving the firmware update patch. The firmware update patch includes code for modifying firmware and a platform signature. The platform signature was generated using a platform private key. The firmware includes a standard mode and a test mode. The method further includes enabling the test mode of the firmware in a setup menu of the firmware. The method further includes authenticating, while the firmware operates in the test mode, the firmware update patch using a platform public key and the platform signature. The platform signature is not sufficient to authenticate the firmware update patch when the firmware operates in the standard mode. The method further includes modifying the firmware based on the firmware update patch to generate modified firmware. The method further includes performing the hardware verification testing on the modified firmware.

The method may further include resetting, after enabling the test mode of the firmware, the firmware.

The firmware update patch may include a manifest header.

The code may include patch files and driver files.

The method may further include determining that the modified firmware passes the hardware verification testing and notifying a computer system operator that the modified firmware passes the hardware verification testing.

The firmware update patch may include the platform public key.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example process for developing, testing, and deploying a firmware update patch.

FIG. 2A illustrates an example development capsule that may be generated by a developer.

FIG. 2B illustrates an example test capsule that a tester may subject to firmware verification testing.

FIG. 2C illustrates an example deployment capsule that a qualification team may subject to system-level testing and deploy in a production environment.

FIG. 3 illustrates an example computing device on which a patch may be deployed for modifying firmware that includes a standard mode and a test mode.

FIG. 4 illustrates an example method for providing a patch for testing.

FIG. 5 illustrates an example method for testing a patch.

FIG. 6 illustrates an example method for deploying a patch in a data center.

FIG. 7 illustrates certain components that can be included within a computing device.

### DETAILED DESCRIPTION

A computing device may include firmware that manages functions of hardware components included in the computing device or associated with the computing device. The firmware may be stored in non-volatile memory of the computing device. The firmware may manage interactions between and among the hardware components of the computing device. The firmware may interact with an operating system of the computing device. The firmware may be a Basic Input/Output System (BIOS) or a Unified Extensible Framework Interface (UEFI). The computing device may be a node in a data center. The hardware components may include processors, memory, input devices, output devices, and networking devices. One or more processors may execute the firmware.

The firmware of the computing device may periodically need to be updated. An update may fix security flaws, adjust hardware settings, fix bugs in firmware functionality, enhance reliability and serviceability features, or enable or disable hardware components. Updating the firmware may include rebooting the computing device and may include replacing the entire firmware with an updated version of the firmware. Because the file size of the firmware may be large, reinstalling the firmware to perform an update may be time-consuming. Consider a data center that is part of a cloud-computing system. The data center may include many servers that provide cloud-computing services to customers. In some cases, such as when a firmware update fixes a major security vulnerability, the firmware update may need to be deployed to all the servers in the data center. In that situation, updating the firmware of the servers may be a costly process that significantly interrupts server availability and impacts revenue the data center can generate.

To reduce the cost of updating the firmware a firmware update patch may be used to update firmware instead of replacing the entire firmware with an updated version. When the computing device executes the firmware update patch, code included in the firmware update patch may modify the firmware while the computing device is running. Moreover, the firmware update patch may modify the firmware without requiring a reboot of the computing device. The firmware update patch may be executed in a highest level of administrative privileges for the computing device. The firmware update patch may be a UEFI runtime patch (URP) capsule. The URP capsule may include instructions for modifying the firmware of the computing device and a URP capsule manifest header. The URP capsule manifest header may include metadata such as a capsule type, a base firmware version, and a URP capsule version number of the URP capsule.

Because a firmware update patch (such as a URP capsule) can be deployed while a computing device (such as a node of a data center) is running, the release of firmware update patches should be controlled so that only authorized and authentic firmware update patches are installed on the computing device. For example, in the case of a data center, only authorized firmware approved by an operator of the data center should be deployed in the data center. Deploying defective or malicious firmware update patches on nodes in the data center could compromise security and node availability.

A variety of methods exist for a computing device to authenticate code before allowing the code to execute on the computing device. One way to protect the computing device from unauthorized code is through signing. Signing is a method for verifying that a package is authentic (i.e., is what it purports to be or comes from a trusted source) and has integrity (i.e., has not been changed). Signing may involve the use of two keys or certificates. The first key may be a private key that is not shared publicly. Access to the private key may be limited and strictly controlled. The private key may be used to generate a signature that is added to a firmware update patch. In some cases, a developer of the firmware update patch may possess the private key and may sign the firmware update patch using the private key. In other cases, an operator of a system on which the firmware update patch is to be installed may possess the private key and sign the firmware update patch using the private key. In other cases, a manufacturer of hardware managed by firmware that is to be updated with the firmware update patch may possess the private key and sign the firmware update patch using the private key.

The second key may be a public key, which may be publicly available or shared freely by whoever possesses the private key. Before allowing a firmware update patch to modify firmware on a computing device, the computing device may use the public key to verify that the signature is authentic. If the firmware update patch is not signed with the private key or has been modified since the signing, the computing device may not authenticate the firmware update patch and may reject the firmware update patch.

Requiring that a firmware update patch include a signature may create problems for testing the firmware update patch and protecting a computing system from defective firmware update patches. For example, a developer may create a firmware update patch that the developer releases to one or more testers. The testers may be original device manufacturers (ODMs) or original equipment manufacturers (OEMs). The ODMs may have developed hardware components managed by the firmware. For a computing device to authenticate the firmware update patch and allow the firmware update patch to modify firmware on the computing device for testing, the firmware update patch may need to be signed. Thus, the developer or the operator may sign the firmware update patch before providing the firmware update patch to one or more ODMs. But once the firmware update patch is signed, a non-testing computing device may accept the firmware update patch as authentic, even if the testing reveals defects in the firmware update patch. The non-testing computing device may be a node in a data center. Deploying the defective firmware update patch on nodes in the data center, whether maliciously or unintentionally, may create widespread security and service-availability issues.

This disclosure concerns processes, systems, and methods for enabling effective testing of firmware update patches while allowing computing devices to distinguish between a firmware update patch that has not yet passed or has failed testing and a firmware update patch that has passed testing and is intended for deployment in a production environment. The disclosed processes, systems, and methods provide computing system operators greater control over their computing systems. A secure firmware update patch release process may include providing (1) a test mode in firmware for performing firmware verification testing on a signed firmware update patch and (2) an additional signing applied after ODM testing and before deployment for distinguishing between deployment-ready firmware update patches and potentially defective firmware update patches.

A developer may develop a payload for including in a firmware update patch. The payload may include instructions for modifying the firmware. The developer may build or use an unsigned version of firmware (such as an unsigned BIOS) as a development and testing environment. The developer may flash the unsigned version of the firmware to the developer's node (such as through Dediprog). Because the firmware is not signed, the developer may be able to build and deploy unsigned firmware update patches to the developer's node. For signed firmware, a signature waiver may not be enabled for security reasons.

Once the developer finishes developing and testing the payload, the developer may build the payload. In some cases, the developer may possess a platform private key, generate a platform signature using the platform private key, and append a platform public key and the platform signature to the payload to generate a test firmware update patch. The platform public key may be used to verify the platform signature. In other cases, the developer may not possess the platform private key. Instead, an operator of a system on which the firmware update patch will be deployed may possess the platform private key. In that case, the operator may receive the payload from the developer, generate the platform signature using the platform private key, and append the platform public key and the platform signature to the payload to generate the test firmware update patch. The operator may append the platform public key and the platform signature to the payload without re-building or modifying the payload. The operator may retain a copy of the test firmware update patch in a release storage deposit. The test firmware update patch may include a header that indicates a version of the test firmware update patch.

The developer or the operator may provide the test firmware update patch to a tester (such as an ODM). The developer or the operator may provide a signed version of the firmware to the tester. Once the tester receives the test firmware update patch, the developer and the operator may not control use and distribution of the test firmware update patch. A setup menu of the signed version of the firmware may enable two modes—a standard mode and a test mode. The test mode may be changeable only at the firmware setup menu and may take effect with a reset.

A computing device on which the firmware is operating may verify authenticity of the test firmware update patch before causing the test firmware patch to modify the firmware. When the firmware operates in the test mode, verifying the authenticity of the firmware update patch may include verifying the authenticity of the platform signature using the platform public key. When the firmware operates in the test mode, the computing device may not verify the authenticity of any additional signatures in the course of verifying the authenticity of the firmware update patch. For example, when the firmware operates in the test mode, the computing device may verify that the test firmware update patch is authentic if the computing device authenticates the platform signature. In contrast, when the firmware operates in the standard mode, the computing device may not verify the authenticity of the firmware update patch unless the computing device authenticates one or more signatures in addition to the platform signature. In other words, when the firmware operates in the standard mode, the platform public key and the platform signature may be insufficient to verify the authenticity of the test firmware update patch.

After the computing device authenticates the test firmware update patch, the computing device may cause the test firmware update patch to modify the firmware to generate modified firmware. The tester may verify that the modified firmware operates correctly. After the tester verifies that the modified firmware operates correctly, the tester may provide the test firmware update patch to a qualification team of the operator. In the alternative, the tester may notify the qualification team or the developer that the test firmware update patch operates correctly. If the modified firmware does not operate correctly, the tester may notify the developer or the qualification team that the modified firmware does not operate correctly.

The qualification team may have access to a computing system, such as a cloud-computing system. The cloud-computing system may include a data center. The qualification team may be able to deploy firmware update patches on nodes of the data center. The qualification team may be much more secure than the tester because the qualification team may be required to have clearance controlled by the operator.

The nodes in the data center may include firmware that has a standard mode and a test mode. The nodes in the data center may operate in the standard mode by default. To accept a firmware update patch as authentic a node operating in the standard mode may require that the firmware update patch include both a platform signature generated using a platform private key and a system signature generated using a system private key. The node may use a system public key to verify the system signature. The firmware update patch may include the system public key. When the firmware update patch is to be deployed on a cloud-computing system, the system public key may be referred to as a cloud public key, the system private key may be referred to as a cloud private key, and the system signature may be referred to as a cloud signature.

If the tester verifies that the modified firmware operates correctly, the operator or the qualification team may add the system public key and the system signature (generated using the system private key) to the test firmware update patch to generate a deployment firmware update patch. The tester may provide a copy of the test firmware update patch to the operator or the qualification team. In the alternative, the tester may identify a version of the test firmware update patch, and the operator or the qualification team may access a stored copy of the version of the test firmware update patch to generate the deployment firmware update patch. It may be beneficial for security purposes that those with access to the system private key not have access to base code of the firmware. Adding the system public key and the system signature to the test firmware update patch may not require a re-build of the payload or the test firmware patch.

The qualification team may use the deployment firmware update patch to perform qualification testing. The qualification team may perform the qualification testing while the firmware operates in the standard mode. This qualification testing may test how the deployment firmware update patch works in a deployment environment of a computing system, such as a cloud-computing system. The qualification testing may be a system-level test instead of a firmware-level test performed by the tester. If the firmware as modified by the deployment firmware update patch operates correctly, the qualification team may deploy the deployment firmware update patch to the computing system (such as to the nodes of the data center). The nodes of the data center may include the firmware operating in the standard mode. The nodes may verify authenticity of the deployment firmware update patch using the platform public key, the platform signature, the cloud public key, and the cloud signature. The nodes of the data center operating in the standard mode may reject a firmware update patch that does not include a verifiable platform signature and a verifiable cloud signature. Thus, the nodes of the data center operating in the standard mode may reject the test firmware update patch because the test firmware update patch does not include the cloud signature.

This secure firmware update patch release process allows system operators to better protect their systems from defective and faulty firmware update patches while allowing for thorough testing of the firmware update patches before deployment. ODMs can perform firmware verification testing on firmware update patches (signed using a platform private key) using signed firmware operating in a test mode. At the same time, a computing system can reject firmware update patches that have not been approved for deployment because such intermediate firmware update patches have not been signed using a system private key.

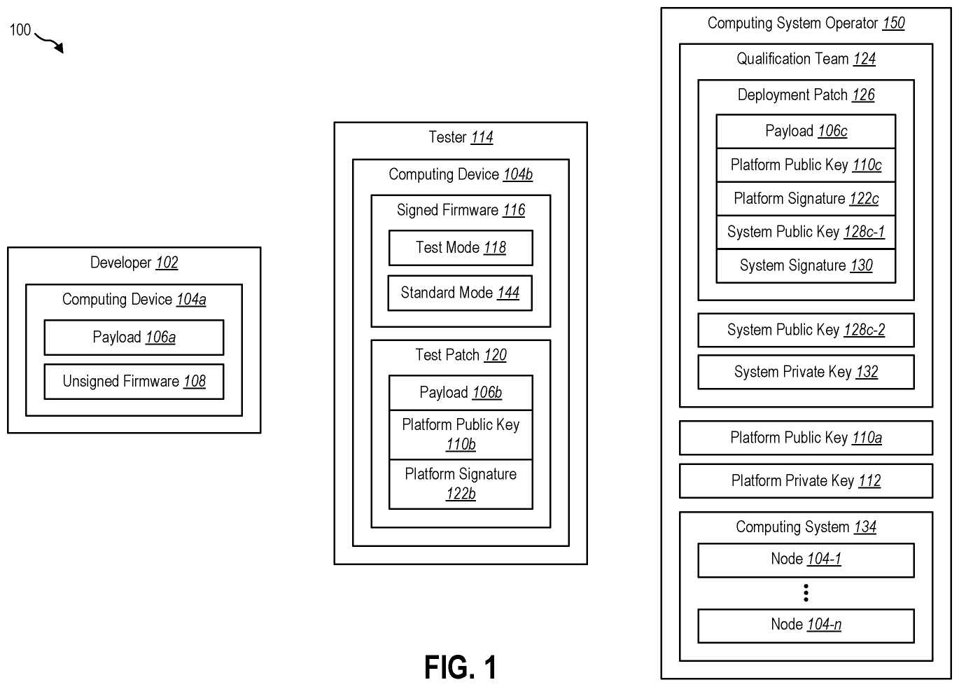

FIG. 1 illustrates an example secure firmware update patch release process 100. The secure firmware update patch release process 100 may involve a developer 102, a tester 114, and a computing system operator 150. In other designs, the secure firmware update patch release process 100 may involve more, fewer, or different parties.

The developer 102 may develop and create code that can be executed on a computing device. The developer 102 may develop and create code for use in a firmware update patch. For example, the developer may develop and create code for including in a payload 106a. The payload 106a may be intended for use in updating firmware that is running on computing devices in a computing system, such as on nodes of a data center. The developer 102 may not be supervised by an operator of the computing system.

The developer 102 may test the payload 106a as part of the development process. The developer 102 may use unsigned firmware 108 on a computing device 104a to test the payload 106a. The developer 102 may use the unsigned firmware 108 (as opposed to signed firmware) because the firmware that the payload 106a is intended to modify may reject any patch that does not include one or more signatures created using one or more private keys. To protect the computing system from potentially malicious patches the developer 102 may not have access to the one or more private keys. As a result, the payload 106a may remain unsigned during development. Unlike the firmware running on the computing system, the unsigned firmware 108 may accept unsigned patches like the payload 106a.

Once the developer 102 finishes developing the payload 106a, the developer 102 may build the payload 106a and release the payload 106a to the computing system operator 150. The computing system operator 150 may append a platform public key 110a and a platform signature to the payload 106a. The computing system operator 150 may append the platform public key 110a and the platform signature to the payload 106a without re-building or modifying the payload 106a. The computing system operator 150 may generate the platform signature using a platform private key 112. The platform signature may be based on the payload 106a. The platform public key 110a may be used to verify the platform signature. The computing system operator 150 may not share the platform private key 112.

The tester 114 may perform firmware verification testing on a firmware update patch. The tester 114 may be an ODM or someone hired by the ODM. The tester 114 may not be under the control of the computing system operator 150. The tester 114 may receive a test patch 120 for firmware verification testing. The test patch 120 may include a payload 106b, a platform public key 110b, and a platform signature 122b. The payload 106b may include code developed, created, and tested by the developer 102. The developer 102 may have built the payload 106b. The payload 106b may be identical to the payload 106a. The platform public key 110b may be identical to the platform public key 110a. The computing system operator 150 may have generated the platform signature 122b using the platform private key 112. The computing system operator 150 may have added the platform public key 110b and the platform signature 122b to the test patch 120 without re-building or modifying the payload 106b.

The tester 114 may perform the firmware verification testing using a computing device 104b. The firmware verification testing may be more extensive than the testing the developer 102 performed while developing the payload 106a. The computing device 104b may include signed firmware 116. The signed firmware 116 may require that the computing device 104b authenticate patches before causing the patches to modify the signed firmware 116. Authenticating a patch may include verifying one or more signatures. The computing device 104b may reject a patch that does not include the verified one or more signatures.

The signed firmware 116 may include a standard mode 144 and a test mode 118. The test mode 118 may be available only in a setup menu of the signed firmware 116. Enabling the test mode 118 may require a restart. The standard mode 144 may be an official operation mode.

The computing device 104b may apply different authentication requirements to a patch when the signed firmware 116 is operating in the test mode 118 as compared to when the signed firmware 116 is operating in the standard mode 144. The test mode 118 may include fewer authentication requirements than the standard mode 144. For example, the test mode 118 may require that a patch include only a first verified signature. The standard mode 144, in contrast, may require that a patch include the first verified signature and a second verified signature. When the signed firmware 116 is operating in the test mode 118, the computing device 104b may accept a patch after verifying the platform signature 122b. The computing device 104b may verify the platform signature 122b using the platform public key 110b. When the signed firmware 116 is operating in the standard mode 144, the computing device 104b may reject a patch that includes only the platform signature 122b and that does not include an additional signature generated using a private key different from the platform private key 112.

The tester 114 may perform firmware verification testing on the test patch 120 while the signed firmware 116 is operating in the test mode 118. The computing device 104b may authenticate the test patch 120 before allowing the test patch 120 to modify the signed firmware 116. Authenticating the test patch 120 may include verifying the platform signature 122b using the platform public key 110b. The computing device 104b may allow the test patch 120 to modify the signed firmware 116 based on verifying the platform signature 122b. The test patch 120 may modify the signed firmware 116 to generate modified firmware. The tester 114 may determine whether the modified firmware operates correctly. The tester 114 may report results of the firmware verification testing to the developer 102 or the computing system operator 150.

The computing system operator 150 may include a qualification team 124, a computing system 134, the platform public key 110a, and the platform private key 112. The qualification team 124 may be controlled by the computing system operator 150. In other words, the computing system operator 150 may determine who is included in the qualification team 124. The qualification team 124 may have access to the computing system 134. The qualification team 124 may perform testing on a deployment patch 126. The testing may include system-level testing. For example, the testing may include determining how the deployment patch 126 operates when deployed in a computing system, such as a cloud-computing system.

The deployment patch 126 may include a payload 106c, a platform public key 110c, a platform signature 122c, a system public key 128c-1, and a system signature 130. The payload 106c may include code developed, created, and tested by the developer 102 and tested by the tester 114. The developer 102 may have built the payload 106c. The platform public key 110c may be identical to the platform public key 110b. The platform signature 122c may be identical to the platform signature 122b.

The qualification team 124 may include a system public key 128c-2 and a system private key 132. The qualification team 124 may use the system private key 132 to generate the system signature 130. The system signature 130 may be based on the payload 106c. The qualification team 124 may add the system public key 128c-1 and the system signature 130 to the deployment patch 126. The system public key 128c-1 may be identical to the system public key 128c-2. The qualification team 124 may add the system public key 128c-1 and the system signature 130 without re-building or modifying the payload 106c. The developer 102 and the tester 114 may not have access to the system private key 132.

The qualification team 124 may deploy the deployment patch 126 on one or more computing devices to perform qualification testing. The one or more computing devices may be part of the computing system 134. For example, the computing system 134 may be a cloud-computing system, and the one or more computing devices may include nodes 104-1 through 104-n. The nodes 104-1 through 104-n may be included in a data center. The qualification team 124 may deploy a copy of the deployment patch 126 on the nodes 104-1 through 104-n as part of qualification testing. If the qualification team 124 determines that the deployment patch 126 passes the qualification testing, the qualification team 124 may deploy the deployment patch 126 on nodes in other data centers. If the qualification team 124 determines that the deployment patch 126 does not pass the qualification testing, the qualification team 124 may deploy a previous version of the firmware on the nodes 104-1 through 104-n.

The nodes 104-1 through 104-n may include firmware. The firmware may include a test mode (such as the test mode 118) and a standard mode (such as the standard mode 144). The firmware may operate in the standard mode by default on the nodes 104-1 through 104-n. When the firmware operates in the standard mode, the nodes 104-1 through 104-n may allow a patch to modify the firmware only if the nodes 104-1 through 104-n verify that the patch includes the platform signature 122c and the system signature 130. In other words, when the firmware operates in the standard mode, authenticating the patch may include verifying the platform signature 122c and verifying the system signature 130. When the firmware operates in the standard mode, if the nodes 104-1 through 104-n cannot verify the system signature 130, the nodes 104-1 through 104-n may reject the patch. The system signature 130 may allow the nodes 104-1 through 104-n to distinguish between the test patch 120 and the deployment patch 126 and to reject the test patch 120 and accept the deployment patch 126. In this way, the nodes 104-1 through 104-n may be protected from intermediate or test patches that include defects revealed through firmware verification testing.

The secure firmware update patch release process 100 allows for thorough firmware verification testing of code prepared by the developer 102 while still protecting the computing system 134 from defective patches. The tester 114 can test code prepared by the developer 102 on the signed firmware 116 by using the test mode 118. The nodes 104-1 through 104-n can reject potentially defective test patches when the test patches do not include a system signature (such as the system signature 130) created using the system private key 132, which the computing system operator 150 may control.

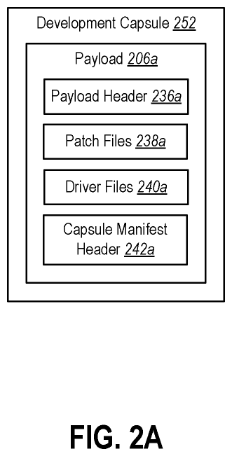

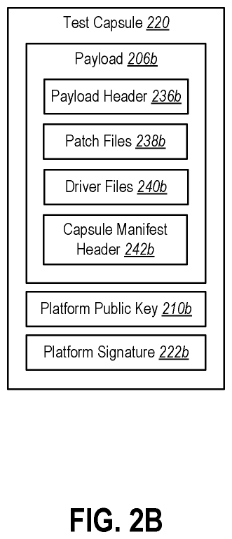

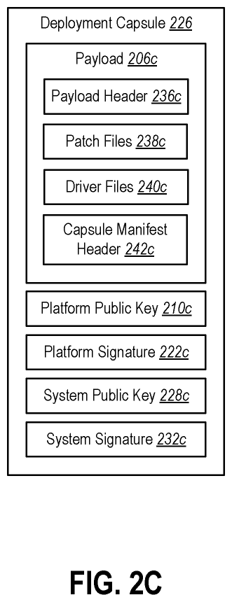

FIG. 2A illustrates an example development capsule 252. The development capsule 252 may be a firmware runtime patch. The development capsule 252 may be a URP capsule. The development capsule 252 may include a payload 206a. The payload 206a may include a payload header 236a, patch files 238a, driver files 240a, and a capsule manifest header 242a. In other designs, the payload 206a may include more or fewer files. The patch files 238a and the driver files 240a may include code instructions to modify firmware of a computing system or a computing device. The code instructions may modify the firmware of the computing system or the computing device while the firmware is running. The firmware may be a BIOS or a UEFI. The patch files 238a and the driver files 240a may be .efi files. The capsule manifest header 242a may be appended at an end of the payload 206a. The capsule manifest header 242a may include metadata such as a capsule type, a base firmware version, and a capsule version number of the development capsule 252. The capsule manifest header 242a may be a URP capsule manifest header.

A developer (such as the developer 102) may generate the development capsule 252. The developer may create the code instructions included in the payload 206a. As part of generating the development capsule 252, the developer may build the payload 206a. The developer may release the development capsule 252 to an operator of a computing system.

FIG. 2B illustrates an example test capsule 220. The test capsule 220 may be a firmware update patch. The test capsule 220 may be a URP capsule. The test capsule 220 may include a payload 206b, a platform public key 210b, and a platform signature 222b. The payload 206b may include a payload header 236b, patch files 238b, driver files 240b, and a capsule manifest header 242b. The payload 206b may be identical to the payload 206a. Similarly, the payload header 236b may be identical to the payload header 236a, the patch files 238b may be identical to the patch files 238a, the driver files 240b may be identical to the driver files 240a, and the capsule manifest header 242b may be identical to the capsule manifest header 242a. The platform signature 222b may be generated using a platform private key. A computing system operator (such as the computing system operator 150) may use the platform private key to generate the platform signature 222b. The platform public key 210b may be used to verify the platform signature 222b.

A tester (such as the tester 114) may perform firmware verification testing on the test capsule 220. The tester may test the test capsule 220 on a computing device with a firmware operating in a test mode (such as the signed firmware 116 and the test mode 118). The tester may notify the operator of the computing system that the test capsule 220 passed the firmware verification testing. In the alternative, the tester may notify the operator of the computing system that the test capsule 220 did not pass the firmware verification testing.

FIG. 2C illustrates an example deployment capsule 226. The deployment capsule 226 may include a payload 206c, a platform public key 210c, a platform signature 222c, a system public key 228c, and a system signature 232c. The payload 206c may include a payload header 236c, patch files 238c, driver files 240c, and a capsule manifest header 242c. The payload 206c may be identical to the payload 206a. Similarly, the payload header 236c may be identical to the payload header 236a, the patch files 238c may be identical to the patch files 238a, the driver files 240c may be identical to the driver files 240a, and the capsule manifest header 242c may be identical to the capsule manifest header 242a. The platform signature 222c may be identical to the platform signature 222b and the platform public key 210c may be identical to the platform public key 210b.

The system signature 232c may be generated using a system private key. A computing system operator (such as the computing system operator 150) may generate the system signature 232c using the system private key. The system public key 228c may be used to verify the system signature 232c. In instances in which the deployment capsule 226 is intended for deployment on computing devices that are part of a cloud-computing system, the system public key 228c may be referred to as a cloud public key, the system signature 232c may be referred to as a cloud signature, and the system private key may be referred to as a cloud private key.

The computing system operator may perform system-level testing and qualification testing on the deployment capsule 226. The computing system operator may test the deployment capsule 226 on one or more computing devices with firmware operating in a standard mode. If the deployment capsule 226 passes the qualification testing, the computing system operator may deploy the deployment capsule 226 on nodes in one or more data centers.

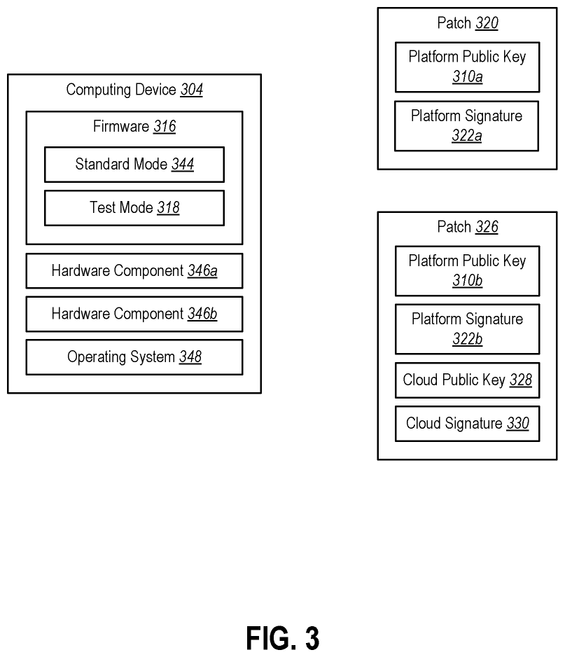

FIG. 3 illustrates a computing device 304, a patch 320, and a patch 326. The computing device 304 may include firmware 316, a hardware component 346a, a hardware component 346b, and an operating system 348. The firmware 316 may manage functions of the hardware components 346a, 346b. The firmware 316 may be stored in non-volatile memory of the computing device 304.

The firmware 316 may include a standard mode 344 and a test mode 318. The test mode 318 may be a setup menu variable and may be an option in the setup menu of the firmware 316. The test mode 318 may be activated only through the setup menu of the firmware 316. The test mode 318 may take effect only with a reset.

The firmware 316 may periodically require updates. The computing device 304 may apply these updates to the firmware 316 through use of a patch. The patch may be a firmware update patch such as a UEFI runtime patch (URP) capsule. The computing device 304 may apply the patch to the firmware 316 while the firmware 316 is running. To protect the firmware 316 and the computing device 304 from malicious software the computing device 304 may verify that a patch is authorized to modify the firmware 316 before causing the patch to modify the firmware 316. Verifying that a patch is authorized to modify the firmware 316 may include verifying that the patch includes one or more signatures that are authentic. The computing device 304 may use one or more public keys to verify the signatures included in the patch. The computing device 304 may include the one or more public keys. In the alternative, the patch may include the one or more public keys.

The computing device 304 may include a verification module to verify that a patch is authorized to modify the firmware 316. The firmware 316 may include the verification module. The verification module may use one or more signatures included in a patch to authenticate the patch. The one or more signatures may have been created using one or more private keys. The one or more signatures may allow the computing device 304 to determine that the patch is authentic and has not been modified. The one or more private keys may not reside on the computing device 304. The verification module may include or use one or more public keys to authenticate the patch. The one or more public keys may allow the computing device 304 to verify that the one or more signatures were generated using the one or more private keys and that the patch (or a payload of the patch) has not been modified since the patch was signed with the one or more signatures. The verification module may include a signature verifying algorithm that receives a patch, a public key, and a signature and determines whether the signature is authentic and whether the patch (or a payload of the patch) has been modified since the patch was signed.

The firmware 316 may include two or more sets of verification checks. The firmware 316 may determine that a patch is authentic if the patch satisfies a set of verification checks. A set of verification checks may include one or more verification checks. The computing device 304 may apply a first set of verification checks when the firmware 316 is operating in the standard mode 344. The computing device 304 may apply a second set of verification checks when the firmware 316 is operating in the test mode 318.

The first set of verification checks may not be identical to the second set of verification checks. The first set of verification checks may include a verification check that is not included in the second set of verification checks. For example, the first set of verification checks may include a first verification check that checks for and verifies a first signature and a second verification check that checks for and verifies a second signature. The second set of verification checks may, however, include only the first verification check that checks for and verifies the first signature and may not include the second verification check that checks for and verifies the second signature. In this way, it may be possible for a patch to pass the second set of verification checks but not the first set of verification checks. In other words, it may be possible for the computing device 304 to authenticate a patch when the computing device 304 applies the second set of verification checks but reject the patch when the computing device applies the first set of verification checks.

The patch 320 may be a firmware update patch (such as the test patch 120 or the test capsule 220). The patch 320 may include code (which may be included in a payload such as the payload 206b) for modifying the firmware 316. A developer (such as the developer 102) may have created the code and built the code for inclusion in the patch 320. The patch 320 may include a platform public key 310a and a platform signature 322a. A computing system operator (such as the computing system operator 150) may have added the platform public key 310a and the platform signature 322a to the patch 320 without re-building or modifying the code.

The patch 326 may be a firmware update patch (such as the deployment patch 126 or the deployment capsule 226). The patch 326 may include code (which may be included in a payload such as the payload 206c) for modifying the firmware 316. A developer (such as the developer 102) may have created the code and built the code for inclusion in the patch 326. The patch 326 may include a platform public key 310b and a platform signature 322b. A computing system operator (such as the computing system operator 150) may have added the platform public key 310b and the platform signature 322b to the patch 326 without re-building or modifying the code. The computing system operator may have provided the patch 326 to a tester (such as the tester 114) for firmware verification testing. The tester may have determined that the patch 326 passed the firmware verification testing. The computing system operator may have added a cloud public key 328 and a cloud signature 330 to the patch 326 after the tester determined that the patch 326 passed the firmware verification testing.

Consider three scenarios in relation to FIG. 3.

Consider a first scenario in which the computing device 304 is being used by a tester. The tester may receive the patch 320. The tester may be tasked by a computing system operator with performing firmware verification testing on the patch 320. The tester may boot the computing device 304 and select the test mode 318 in a setup menu of the firmware 316. The computing device 304 may reset and operate with the firmware 316 operating in the test mode 318. The test mode 318 may include a set of test mode verification checks. The set of test mode verification checks may include checking for a platform signature and verifying the platform signature. The set of test mode verification checks may not include checking for and verifying any other signature. The set of test mode verification checks may not include a check for a cloud signature.

In the first scenario, the tester may deploy the patch 320 on the computing device 304 (while the firmware 316 is operating in the test mode 318) to perform firmware verification testing. Before causing the patch 320 to modify the firmware 316, the computing device 304 may verify that the patch 320 is authorized to modify the firmware 316. Because the firmware 316 is operating in the test mode 318, the computing device 304 may apply the set of test mode verification checks. The computing device 304 may use the platform public key 310a to verify the platform signature 322a. The computing device 304 may determine that the platform signature 322a is authentic. Based solely or in part on verifying the platform signature 322a, the computing device 304 may determine that the patch 320 is authorized to modify the firmware 316. The computing device 304 may cause the patch 320 to modify the firmware 316. The tester may perform firmware verification testing on the modified firmware.

Consider a second scenario in which the computing device 304 is a node in a data center. Assume that a computing system operator provided the patch 320 to a tester (such as the tester 114) for firmware verification testing. Assume that the tester determined that the patch 320 contains defects and that the patch 320 should not be deployed in a production environment. Assume that the standard mode 344 of the firmware 316 includes a set of standard mode verification checks. The set of standard mode verification checks may include checking for a platform signature and verifying the platform signature. The set of standard mode verification checks may also include checking for a cloud signature and verifying the cloud signature.

In the second scenario, consider that a malicious actor smuggles the patch 320 into the data center and onto the computing device 304. Assume that the firmware 316 is operating in the standard mode 344. When the malicious actor smuggles the patch 320 onto the computing device 304, the computing device 304 may perform the set of standard mode verification checks on the patch 320. The computing device 304 may verify the platform signature 322a. But the computing device 304 may reject the patch 320 because the patch 320 does not include the cloud signature. As a result, the computing device 304 may not allow the patch 320 to modify the firmware 316.

Consider a third scenario in which the computing device 304 is a node in a data center that provides cloud-computing services. Assume that a tester performed firmware verification testing on the patch 326 and determined that the patch 326 passed the firmware verification testing. Assume that a computing system operator performed additional testing on the patch 326 and determined that the patch 326 can be deployed in the data center. Assume that the computing device 304 is operating in the standard mode 344 and that the standard mode 344 includes a set of standard mode verification checks identical to the set of standard mode verification checks described in the second scenario.

In the third scenario, the computing system operator may deploy the patch 326 on the computing device 304. The computing device 304 may apply the set of standard mode verification checks to the patch 326. The computing device 304 may verify the platform signature 322b using the platform public key 310b and may verify the cloud signature 330 using the cloud public key 328. Based solely or in part on verifying the platform signature 322b and the cloud signature 330, the computing device 304 may determine that the set of standard mode verification checks are satisfied and cause the patch 326 to modify the firmware 316.

As shown in the first scenario, the second scenario, and the third scenario, using a test mode and a cloud signature allow a computing system operator to better protect computing devices in a computing system from defective patches. A patch can be thoroughly tested on authentic hardware through use of a test mode in firmware. But if testing reveals defects in the patch, the computing system can reject the defective patch because a patch (or a copy of the patch) may not receive a cloud signature from the computing system operator until the patch passes firmware verification testing.

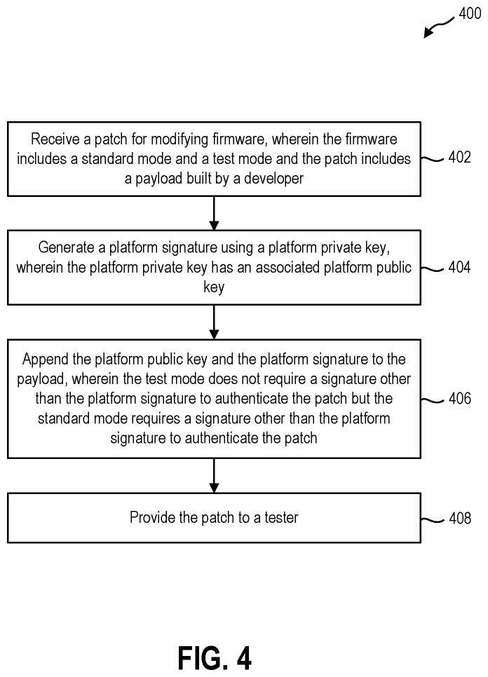

FIG. 4 illustrates an example method 400 for enabling testing of a patch.

The method 400 may include receiving 402 a patch for modifying firmware, wherein the firmware includes a standard mode and a test mode and the patch includes a payload built by a developer. The patch may be a URP capsule. A computing system operator (such as a cloud-computing system operator) may receive the patch.

The method 400 may include generating 404 a platform signature using a platform private key, wherein the platform private key has an associated platform public key. The computing system operator may generate 404 the platform signature using the platform private key. The computing system operator may restrict access to the platform private key. The computing system operator may share the platform public key. Generating 404 the platform signature using the platform private key may include generating the platform signature based on the payload.

The method 400 may include appending 406 the platform public key and the platform signature to the payload, wherein the test mode does not require a signature other than the platform signature to authenticate the patch but the standard mode requires a signature other than the platform signature to authenticate the patch. Appending 406 the platform public key and the platform signature may not include re-building or modifying the payload. The signature other than the platform signature may be a system signature. The computing system operator may posses a system private key that is used to generate the system signature. The computing system operator may not generate the system signature for the patch unless and until the patch passes firmware verification testing.

The method 400 may include providing 408 the patch to a tester. The tester may be an ODM. The tester may perform firmware verification testing on the patch.

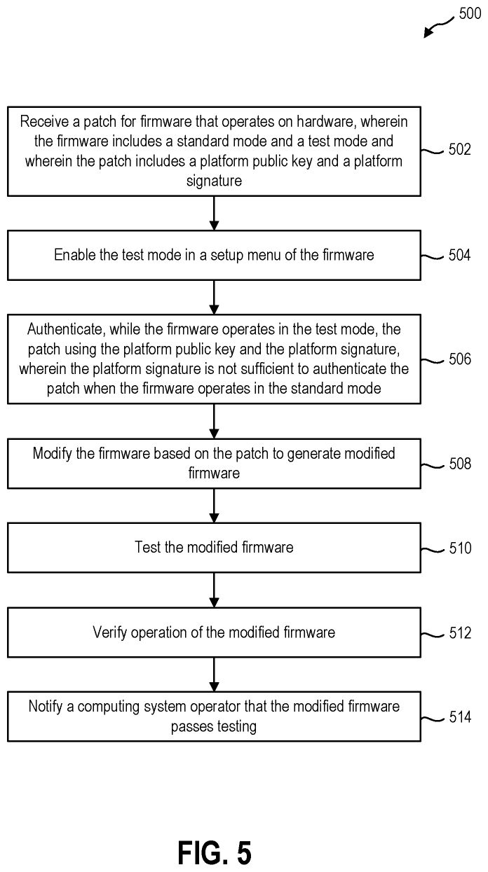

FIG. 5 illustrates an example method 500 for testing a patch.

The method 500 may include receiving 502 a patch for firmware that operates on hardware, wherein the firmware includes a standard mode and a test mode and wherein the patch includes a platform public key and a platform signature. A tester may receive 502 the patch. The tester may deploy the patch on a computing device that includes the hardware. The computing device may include the firmware.

The method 500 may include enabling 504 the test mode in a setup menu of the firmware. The tester may enable 504 the test mode in the setup menu of the firmware. Enabling 504 the test mode in the setup menu of the firmware may be the only way to enable the test mode. Enabling 504 the test mode in the setup menu of the firmware may include resetting the firmware.

The method 500 may include authenticating 506, while the firmware operates in the test mode, the patch using the platform public key and the platform signature, wherein the platform signature is not sufficient to authenticate the patch when the firmware operates in the standard mode. The computing device may not allow the patch to modify the firmware unless and until the computing device authenticates the patch. The computing device may reject the patch if the computing device cannot authenticate the patch.

The method 500 may include modifying 508 the firmware based on the patch to generate modified firmware. Modifying 508 the firmware based on the patch to generate the modified firmware may occur during runtime.

The method 500 may include testing 510 the modified firmware. Testing 510 the modified firmware may include performing firmware verification testing on the modified firmware. The tester may test 510 the modified firmware.

The method 500 may include verifying 512 operation of the modified firmware. Verifying 512 the operation of the modified firmware may include determining that the computing device and hardware components of the computing device operate correctly with the modified firmware.

The method 500 may include notifying 514 a computing system operator that the modified firmware passes testing. Notifying 514 the computing system operator that the modified firmware passes testing may include notifying the computing system operator of a version of the patch. The computing system operator may possess copies of multiple versions of the patch. The computing system operator may select the version of the patch. A qualification team of the computing system operator may generate a cloud signature based on the version of the patch using a cloud private key. The qualification team may append a cloud public key associated with the cloud private key and the cloud signature to the patch. The qualification team may perform qualification testing on the patch. The qualification team may deploy the patch on nodes in one or more data centers after performing qualification testing on the patch.

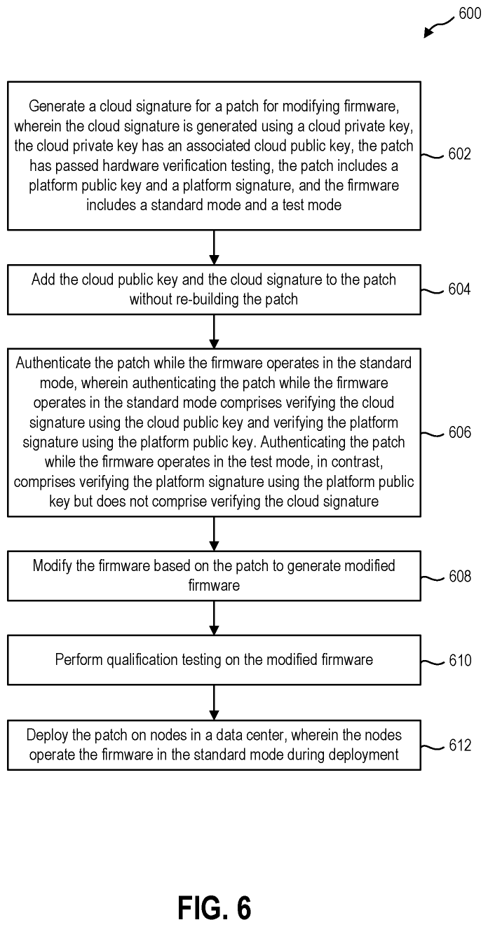

FIG. 6 illustrates an example method 600 for deploying a patch.

The method 600 may include generating 602 a cloud signature for a patch for modifying firmware, wherein the cloud signature is generated with a cloud private key, the cloud private key has an associated cloud public key, the patch has passed hardware verification testing, the patch includes a platform public key and a platform signature, and the firmware includes a standard mode and a test mode. A release engineer or a program manager of a computing system operator may generate 602 the cloud signature for the patch. The release engineer and the program manager may have access to the cloud private key. The release engineer and the program manager may not share the cloud private key. The release engineer and the program manager may not have access to code of the firmware.

The method 600 may include adding 604 the cloud public key and the cloud signature to the patch without re-building the patch. The release engineer may add 604 the cloud public key and the cloud signature to the patch without re-building the patch or modifying code in the patch that modifies the firmware.

The method 600 may include authenticating 606 the patch while the firmware operates in the standard mode, wherein authenticating the patch while the firmware operates in the standard mode comprises verifying the cloud signature using the cloud public key and verifying the platform signature using the platform public key. Authenticating the patch while the firmware operates in the test mode, in contrast, comprises verifying the platform signature using the platform public key but does not comprise verifying the cloud signature.

The method 600 may include modifying 608 the firmware based on the patch to generate modified firmware. The firmware may reside on a node in a data center.

The method 600 may include performing 610 qualification testing on the modified firmware. A qualification team of the computing system operator may perform 610 the qualification testing. The qualification testing may be system-level testing.

The method 600 may include deploying 612 the patch on nodes in a data center, wherein the nodes operate the firmware in the standard mode during deployment. The qualification team may deploy 612 the patch on the nodes in the data center.

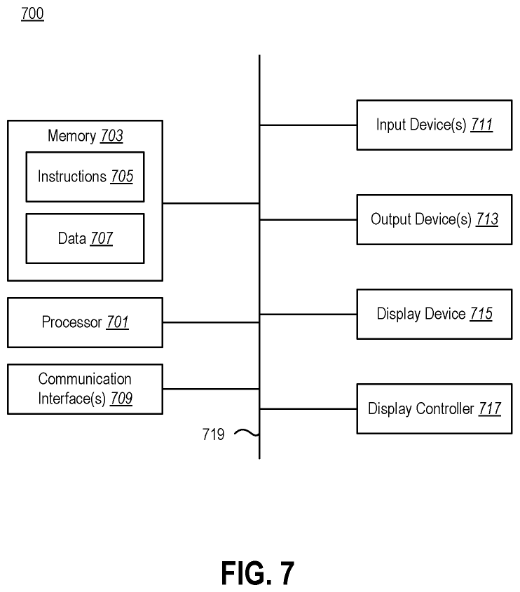

Reference is now made to FIG. 7. One or more computing devices 700 can be used to implement at least some aspects of the techniques disclosed herein. FIG. 7 illustrates certain components that can be included within a computing device 700.

The computing device 700 includes a processor 701 and memory 703 in electronic communication with the processor 701. Instructions 705 and data 707 can be stored in the memory 703. The instructions 705 can be executable by the processor 701 to implement some or all of the methods, steps, operations, actions, or other functionality that is disclosed herein. Executing the instructions 705 can involve the use of the data 707 that is stored in the memory 703. Unless otherwise specified, any of the various examples of modules and components described herein can be implemented, partially or wholly, as instructions 705 stored in memory 703 and executed by the processor 701. Any of the various examples of data described herein can be among the data 707 that is stored in memory 703 and used during execution of the instructions 705 by the processor 701.

Although just a single processor 701 is shown in the computing device 700 of FIG. 7, in an alternative configuration, a combination of processors (e.g., an Advanced RISC (Reduced Instruction Set Computer) Machine (ARM) and a digital signal processor (DSP)) could be used.

The computing device 700 can also include one or more communication interfaces 709 for communicating with other electronic devices. The communication interface(s) 709 can be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The computing device 700 can also include one or more input devices 711 and one or more output devices 713. Some examples of input devices 711 include a keyboard, mouse, microphone, remote control device, button, joystick, trackball, touchpad, and lightpen. One specific type of output device 713 that is typically included in a computing device 700 is a display device 715. Display devices 715 used with embodiments disclosed herein can utilize any suitable image projection technology, such as liquid crystal display (LCD), light-emitting diode (LED), gas plasma, electroluminescence, wearable display, or the like. A display controller 717 can also be provided, for converting data 707 stored in the memory 703 into text, graphics, and/or moving images (as appropriate) shown on the display device 715. The computing device 700 can also include other types of output devices 713, such as a speaker, a printer, etc.

The various components of the computing device 700 can be coupled together by one or more buses, which can include a power bus, a control signal bus, a status signal bus, a data bus, etc. For the sake of clarity, the various buses are illustrated in FIG. 7 as a bus system 719.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, various types of storage class memory, on-board memory included with a processor, erasable programmable read-only memory (EPROM), electrically erasable programmable read-only memory (EEPROM) memory, registers, and so forth, including combinations thereof.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for enabling hardware verification testing of a firmware update patch, the method comprising:
receiving the firmware update patch, wherein the firmware update patch includes a payload, the payload includes code for modifying firmware, the firmware includes a standard mode and a test mode, and the standard mode has a first set of verification checks for authenticating a patch that is different from a second set of verification checks for authenticating a patch of the test mode;
generating a platform signature using a platform private key and the firmware update patch;
adding the platform signature to the firmware update patch, wherein the second set of verification checks of the test mode does not require a signature other than the platform signature to authenticate the firmware update patch but the first set of verification checks of the standard mode requires a signature other than the platform signature to authenticate the firmware update patch; and
providing the firmware update patch to a tester.

2. The method of claim 1, wherein a developer built the payload and adding the platform signature to the firmware update patch does not require re-building the payload.

3. The method of claim 1, wherein the payload comprises a payload header.

4. The method of claim 1, wherein the firmware is a Basic Input/Output System (BIOS) or a Unified Extensible Framework Interface (UEFI).

5. The method of claim 4, wherein the firmware update patch is a UEFI runtime patch (URP) capsule.

6. The method of claim 1 further comprising: adding a platform public key to the firmware update patch, wherein the platform public key can authenticate the platform signature.

7. The method of claim 1, wherein the test mode of the firmware can be selected only in a startup menu of the firmware.

8. A system for authenticating a firmware update patch for deployment on a node in a data center, the system comprising:
one or more processors;
memory in electronic communication with the one or more processors;
one or more hardware components;
firmware for managing the one or more hardware components, wherein the firmware includes a standard mode and a test mode, and the standard mode includes a standard set of verification checks different from a test set of verification checks included in the test mode; and
instructions stored in the memory, the instructions being executable by the one or more processors to:
receive the firmware update patch, wherein the firmware update patch includes a platform signature and a cloud signature, wherein the platform signature was generated using a platform private key and the cloud signature was generated using a cloud private key different from the platform private key;
authenticate the firmware update patch while the firmware operates in the standard mode using the standard set of verification checks, wherein the standard set of verification checks comprises:
verifying the platform signature; and
verifying the cloud signature;
cause, after authenticating the firmware update patch, the firmware update patch to modify the firmware to generate modified firmware; and
manage the one or more hardware components based on the modified firmware.

9. The system of claim 8, wherein verifying the platform signature comprises verifying the platform signature using a platform public key included in the firmware update patch.

10. The system of claim 98, wherein verifying the cloud signature comprises verifying the cloud signature using a cloud public key included in the firmware update patch.

11. The system of claim 8, wherein the firmware update patch underwent hardware verification testing while the firmware update patch included the platform signature but before the firmware update patch included the cloud signature.

12. The system of claim 8, wherein the cloud signature was added to the firmware update patch by an operator of the data center.

13. The system of claim 8, wherein the test set of verification checks does not include verifying the cloud signature.

14. The system of claim 8, wherein the firmware is a Unified Extensible Framework Interface (UEFI) and the firmware update patch is a UEFI runtime patch (URP) capsule.

15. A method for performing hardware verification testing of a firmware update patch, the method comprising:
receiving the firmware update patch, wherein the firmware update patch includes code for modifying firmware and a platform signature, wherein the platform signature was generated using a platform private key, and wherein the firmware includes a standard mode and a test mode;
enabling the test mode of the firmware in a setup menu of the firmware;
authenticating, while the firmware operates in the test mode, the firmware update patch using a platform public key and the platform signature, wherein the platform signature is not sufficient to authenticate the firmware update patch when the firmware operates in the standard mode;
modifying the firmware based on the firmware update patch to generate modified firmware; and
performing the hardware verification testing on the modified firmware.

16. The method of claim 15 further comprising: resetting, after enabling the test mode of the firmware, the firmware.

17. The method of claim 15, wherein the firmware update patch includes a manifest header.

18. The method of claim 15, wherein the code includes patch files and driver files.

19. The method of claim 15 further comprising:
determining that the modified firmware passes the hardware verification testing; and
notifying a computer system operator that the modified firmware passes the hardware verification testing.

20. The method of claim 15, wherein the firmware update patch includes the platform public key.
